(19) United States
(12) Patent Application Publication
(10) Pub. No.: US 2025/0168198 A1
(43) Pub. Date: May 22, 2025

(54) METHODS AND SYSTEMS FOR AI-DRIVEN POLICY GENERATION

(71) Applicants: STEPHEN TUCKER, Richmond, VA (US); RATHINASABAPATHY ARUMUGAM, SAMMAMISH, WA (US); SRIDHAR CHANDRASHEKAR, SAMMAMISH, WA (US)

(72) Inventors: STEPHEN TUCKER, Richmond, VA (US); RATHINASABAPATHY ARUMUGAM, SAMMAMISH, WA (US); SRIDHAR CHANDRASHEKAR, SAMMAMISH, WA (US)

(21) Appl. No.: 18/748,461

(22) Filed: Jun. 20, 2024

Related U.S. Application Data
(60) Provisional application No. 63/524,296, filed on Jun. 30, 2023.

(51) Int. Cl. H04L 9/40; G06F 40/30

(52) U.S. Cl. CPC H04L 63/20; G06F 40/30

(57) ABSTRACT

In one aspect, a method of an managing policies in a multi-cloud governance platform comprising: implementing AI-driven policy generation in the multi-cloud governance platform by: providing at least one large language model (LLM) with sufficient size to have near or better than human reasoning abilities as an emergent property of the LLM; providing a plurality of cloud-computing platform dynamically updated documentations; with the LLM, interpreting an existing policy of a cloud-computing platform as provided in the plurality of cloud-computing platform dynamically updated documentations; with the by the LLM, generating executable check, for a compliance with a policy of the cloud-computing platform; and with the LLM, creating and maintaining a plurality of resources or activities associated with the policy for at least one cloud instance of the cloud-computing platform.

### CLAIM OF PRIORITY

This application claims priority to U.S. Provisional Patent Application No. 63/524,296, filed on 30 Jun. 2023, and titled METHODS AND SYSTEMS FOR AI-DRIVEN POLICY GENERATION. This provisional patent application is hereby incorporated by reference in its entirety.

### BACKGROUND

Security and Compliance rapidly evolving in cloud-computing world. Unlike the traditional systems, physical and boundary protection is no longer sufficient in protecting the assets provisioned in the cloud.

In addition to that Compliance regulations and Industry benchmarks are redefined every year and cloud assets need to adhere to the newer regulations and industry benchmarks to safeguard their customer information and reputation.

Additionally, there is a need to continuously monitor compliance controls, security threats and vulnerabilities across the assets provisioned in multi-cloud environments.

Additionally, A cloud governance policy is a set of rules and guidelines that define how an organization's cloud resources should be managed and used.

These policies aim to ensure that the organization's cloud environment is secure, efficient, and aligns with business objectives. They cover various aspects including security, compliance, cost management, performance, and operational excellence.

Creating and verifying compliance for a governance policy often requires reasoning because the cloud environment is complex and dynamic, with various services and resources interacting in numerous ways. The policy needs to consider the overall architecture, the specific use-cases, as well as regulatory requirements and industry best practices.

As a result, policies are created manually since traditional ML and data engineering approaches rely on either syntactic (regex, etc.) mechanisms or word or phrase similarity, which are insufficient for handling arbitrary nomenclature and goal and rule expressions.

Furthermore, there are no clear traditional ML approaches for comparing and assimilating compliance requirements from disparate standards bodies.

### BRIEF SUMMARY OF THE INVENTION

In one aspect, a method of an managing policies in a multi-cloud governance platform comprising: implementing AI-driven policy generation in the multi-cloud governance platform by: providing at least one large language model (LLM) with sufficient size to have near or better than human reasoning abilities as an emergent property of the LLM; providing a plurality of cloud-computing platform dynamically updated documentations; with the LLM, interpreting an existing policy of a cloud-computing platform as provided in the plurality of cloud-computing platform dynamically updated documentations; with the by the LLM, generating executable check, for a compliance with a policy of the cloud-computing platform; and with the LLM, creating and maintaining a plurality of resources or activities associated with the policy for at least one cloud instance of the cloud-computing platform.

### BRIEF DESCRIPTION OF THE DRAWINGS

FIG. 1 illustrates an example process for implementing AI-driven policy generation., according to some embodiments.

FIG. 2 is a block diagram of a sample computing environment that can be utilized to implement various embodiments.

The Figures described above are a representative set and are not an exhaustive with respect to embodying the invention.

### DESCRIPTION

Disclosed are a system, method, and article of manufacture for AI-driven policy generation. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided. These example definitions can be incorporated into example embodiments discussed infra.

Amazon Web Services, Inc. (AWS) is an on-demand cloud computing platform(s) and API( )s. These cloud-computing web services can provide distributed computing processing capacity and software tools via AWS server farms. AWS can provide a virtual cluster of computers, available all the time, through the Internet. The virtual computers can emulate most of the attributes of a real computer, including hardware central processing units (CPUs) and graphics processing units (GPUs) for processing; local/RAM memory; hard-disk/SSD storage; a choice of operating systems; networking; and pre-loaded application software such as web servers, databases, and customer relationship management (CRM).

Microsoft Azure (e.g. Azure as used herein) is a cloud computing service operated by Microsoft for application management via Microsoft-managed data centers. It provides software as a service (Saas), platform as a service (PaaS) and infrastructure as a service (IaaS) and supports many different programming languages, tools, and frameworks, including both Microsoft-specific and third-party software and systems.

Cloud computing architecture refers to the components and subcomponents required for cloud computing. These components typically consist of a front-end platform (fat client, thin client, mobile), back-end platforms (servers, storage), a cloud-based delivery, and a network (Internet, Intranet, Intercloud). Combined, these components can make up cloud computing architecture. Cloud computing architectures and/or platforms can be referred to as the ‘cloud’ herein as well.

Cloud resource model (CRM) provides ability to define resource characteristics, Hierarchy, dependencies, and its action in a declarative model and embed them in Open API specification. CRM allows both humans and computers to understand and discover capabilities and characteristics of cloud service and its resources.

Cyber security is the protection of computer systems and networks from information disclosure, theft of, or damage to their hardware, software, or electronic data, as well as from the disruption or misdirection of the services they provide.

Deep learning is part of a broader family of machine learning methods based on artificial neural networks with representation learning. Learning can be supervised, semi-supervised or unsupervised.

Deep neural network (DNN) is an artificial neural network (ANN) with multiple layers between the input and output layers. There are different types of neural networks, but they always consist of the same components: neurons, synapses, weights, biases, and functions.

Generative artificial intelligence or generative AI is a type of artificial intelligence (AI) system capable of generating text, images, or other media in response to prompts. Generative models learn the patterns and structure of the input data, and then generate new content that is similar to the training data but with some degree of novelty (e.g. rather than only classifying or predicting data).

Generative pre-trained transformers (GPT) are a type of large language model (LLM) and a prominent framework for generative artificial intelligence. GPT models are artificial neural networks that are based on the transformer architecture, pre-trained on large data sets of unlabeled text, and able to generate novel human-like content.

Generative adversarial network (GAN) is a class of machine learning frameworks and a prominent framework for approaching generative AI. In a GAN, two neural networks contest with each other in the form of a zero-sum game, where one agent's gain is another agent's loss. Given a training set, this technique learns to generate new data with the same statistics as the training set. For example, a GAN trained on photographs can generate new photographs that look at least superficially authentic to human observers, having many realistic characteristics. Though originally proposed as a form of generative model for unsupervised learning, GANs have also proved useful for semi-supervised learning, fully supervised learning, and reinforcement learning. The core idea of a GAN is based on the “indirect” training through the discriminator, another neural network that can tell how “realistic” the input seems, which itself is also being updated dynamically. This means that the generator is not trained to minimize the distance to a specific image, but rather to fool the discriminator. This enables the model to learn in an unsupervised manner.

Hyperscalers can be large cloud service providers. Hyperscalers can be the owners and operators of data centers where these horizontally linked servers are housed.

Identity and access management (IAM) can be a framework of policies and technologies to ensure that the right users (e.g. that are part of the ecosystem connected to or within an enterprise) have the appropriate access to technology resources. IAM systems are part of an IT security and data management schema. IAM systems can not only identify, authenticate, and control access for individuals who will be utilizing IT resources but also the hardware and applications employees need to access.

Large language model (LLM) can be a language model consisting of a neural network with many parameters (e.g. billions of weights or more), trained on large quantities of unlabeled text using self-supervised learning or semi-supervised learning. Though the term large language model has no formal definition, it often refers to deep learning models having a parameter count on the order of billions or more. LLMs can be general purpose models which excel at a wide range of tasks (e.g. including annotating web page elements, interfacing with a user selecting web page elements, identifying the context of web page elements, etc.). It is noted that in some embodiments, natural language processing methods can also be used that train specialized supervised models for specific tasks (e.g. annotated web page elements, sentiment analysis of users and/or web page element content and/or context, named entity recognition of users and/or web page element content and/or context, or mathematical reasoning operations, etc.).

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, logistic regression, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Natural language processing (NLP) is a branch of artificial intelligence concerned with automated interpretation and generation of human language. Natural language processing (NLP) is an interdisciplinary subfield of linguistics, computer science, and artificial intelligence concerned with the interactions between computers and human language, in particular how to program computers to process and analyze large amounts of natural language data. NLP systems used herein are capable of understanding the contents of documents, including the contextual nuances of the language within them. The technology can then accurately extract information and insights contained in the documents as well as categorize and organize the documents themselves. NLP systems used herein can include the following systems, inter alia: speech recognition, natural-language understanding, and natural-language generation.

Operational semantics is a category of formal programming language semantics in which certain desired properties of a program, such as correctness, safety or security, are verified by constructing proofs from logical statements about its execution and procedures, rather than by attaching mathematical meanings to its terms (e.g. denotational semantics).

Prompt engineering is the process of structuring an instruction that can be interpreted and understood by a generative AI model. A prompt is natural language text describing the task that an AI should perform. A prompt for a text-to-text language model can be a query such as “what is Fermat's little theorem?”, a command such as “write a poem about leaves falling”, or a longer statement including context, instructions, and conversation history. Prompt engineering may involve phrasing a query, specifying a style, providing relevant context or assigning a role to the AI such as “Act as a native French speaker”. A prompt may include a few examples for a model to learn from, such as asking the model to complete “maison→house, chat→cat, chien→” (the expected response being dog), an approach called few-shot learning. When communicating with a text-to-image or a text-to-audio model, a typical prompt is a description of a desired output such as “a high-quality photo of an astronaut riding a horse” or “Lo-fi slow BPM electro chill with organic samples”. Prompting a text-to-image model may involve adding, removing, emphasizing and re-ordering words to achieve a desired subject, style, layout, lighting, and aesthetic.

Security Operations (SecOps) combines information technology (IT) security and operations methods and can integrates tools, processes, and technology to maintain security and reduce risk. Cloud SecOps can be an important function for providing robust and effective security for cloud-based infrastructure. Cloud-based SecOps for cloud-based systems/services can be different from traditional infrastructure security function as it can handle security for multiple cloud-based services, components, and resources. Cloud-based systems can provide agility and hence there is potential increased security risk. Cloud-based SecOps covers people, process, technology, services, and/or tools needed to identify and manage threat exposure, ensure compliance and to prevent, detect and respond to cybersecurity incidents cloud-based SecOps brings to obtain cloud-based operations, security and compliance to better coordinate priorities and optimize communication, while integrating automation to ensure fast and secure software delivery which is compliant with regulatory and compliance standards. Cloud-based SecOps can use a compliance controls and policy (e.g. detective guardrails) execution framework which enables to automate the compliance controls and policies which will run against the resources deployed in the multi cloud environment. The compliance controls and policy execution framework uses multiple technical components such as converged policy engine, abstracted cloud compliance framework, compliance BOT, inventor visibility, access visibility and reports.

Software development kit (SDK) is a collection of software development tools in one installable package. They facilitate the creation of applications by having a compiler, debugger and sometimes a software framework. They are normally specific to a hardware platform and operating system combination. To create applications with advanced functionalities such as advertisements, push notifications, etc.; most application software developers use specific software development kits.

### EXAMPLE SYSTEMS AND METHODS

A multi-cloud governance platform is provided that empowers enterprises to rapidly achieve autonomous and continuous cloud governance and compliance at scale. Multi-cloud governance platform is delivered to end users in the form of multiple product offerings, bundled for a specific set of cloud governance pillars based on the client's needs. Example multi-cloud governance platform's offerings and associated cloud governance pillars are now discussed.

The multi-cloud governance platform can provide FinOps as a solution offering that is designed to help an entity develop a culture of financial accountability and realize the benefits of the cloud faster. The multi-cloud governance platform SecOps as a solution offering designed to help keep cloud assets secure and compliant. The multi-cloud governance platform is a solution offering designed to help optimize cloud operations and cost management in order to provide accessibility, availability, flexibility, and efficiency while also boosting business agility and outcomes. The multi-cloud governance platform provides a compass that is designed to help an entity adopt best practices according to well-architected frameworks, gain continuous visibility, and manage risk of cloud workloads with assessments, policies, and reports that allow an administrator to review the state of applications and get a clear understanding of risk trends over time.

Cloud Governance Pillars that can be implemented by the multi-cloud governance platform are now discussed. The multi-cloud governance platform can enable governing of cloud assets involves cost-efficient and effective management of resources in a cloud environment while adhering to security and compliance standards. There are several factors that can be involved in a successful implementation of cloud governance. The multi-cloud governance platform has encompassed all these factors into its cloud governance pillars. The following table explains the key cloud governance pillars developed by Multi-cloud governance platform.

The multi-cloud governance platform utilizes various operations that provide the capability to operate and manage various cloud resources efficiently using various features such as automation, monitoring, notifications, activity tracking.

The multi-cloud governance platform utilizes various security operations that enable management of the security governance of various cloud accounts and identify the security vulnerabilities and threats and resolve them.

The multi-cloud governance platform utilizes various manages cost. The multi-cloud governance platform enables users to create a customized controlling mechanism that can control your cloud expenses within budget and reduce cloud waste by continually discovering and eliminating inefficient resources.

The multi-cloud governance platform utilizes various access operations. The multi-cloud governance platform utilizes various allows administrators to configure secure access of resources in your cloud environment and protect the users' data and assets from unauthorized access.

The multi-cloud governance platform utilizes various resource management operations. The multi-cloud governance platform enables users to define, enforce, and track the resource naming and tagging standards, sizing, and their usage by region. It also enables you to follow consistent and standard practices pertaining to resource deployment, management, and reporting.

The multi-cloud governance platform utilizes various compliance actions. The multi-cloud governance platform guides users to assess a cloud environment for its compliance status against standards and regulations that are relevant to your organization-ISO, NIST, HIPAA, PCI, CIS, FedRAMP, AWS Well-Architected framework, and custom standards.

The multi-cloud governance platform utilizes various self-service operations. The multi-cloud governance platform enables administrators to configure a simplified self-service cloud consumption model for end users that are tied to approval workflows. It enables an entity to automate repetitive tasks and focus on key deliverables.

### AI-Driven Policy Generation

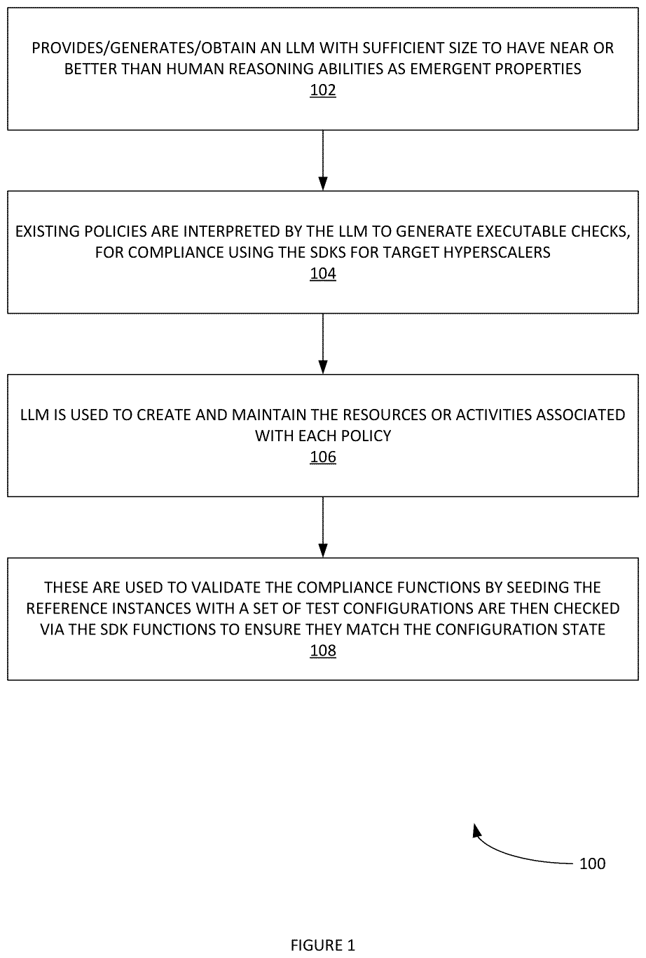

FIG. 1 illustrates an example process 100 for implementing AI-driven policy generation, according to some embodiments. Process 100 defines an approach whereby human reasoning can be replaced by generative AI reasoning and thus allow the process to be automated and updated automatically. Process 100 utilizes the following major steps. In step 102, process 100 provides/generates/obtain an LLM with sufficient size to have near or better than human reasoning abilities as emergent properties. GPT-4 is an example of an LLM that satisfies this requirement.

In step 104, existing policies are interpreted by the LLM to generate executable checks (e.g. rules), for compliance using the SDKs for target hyperscalers (e.g. a cloud-computing platform, etc.). In step 106, the LLM is used to create and maintain the resources or activities associated with each policy. This can include various reference cloud instances for each hyperscaler.

In step 108, these are used to validate the compliance functions by seeding the reference instances with a set of test configurations that are then checked via the SDK functions to ensure they match the configuration state. Process 100 can implement additional code to perform prompt engineering and Retrieval Augmented Generation (RAG) to perform various semantic operations on policies and elicit the correct SDK code for each rule required by the policy.

Before now, there were no technologies that could provide near or better than human level reasoning using natural language. Reasoning agents were either specific to a particular problem domain or required a formal language to solve problems. The emergent properties of LLMs like GPT-4 provide sufficient reasoning abilities to replace human reasoning in compliance policy design, articulation, and auditing.

The GPT model is pre-trained on plurality of cloud computing platform documentations and generates human-like content summaries of the plurality of cloud computing platform documentations to a user of the multi-cloud computing platform.

The emergent properties of the GPT model that is pre-trained on plurality of cloud computing platform documentations and generates human-like content summaries of the plurality of cloud computing platform documentations are now discussed. The performance of GPT model on various tasks, when plotted on a log-log scale, can have a linear extrapolation of performance achieved by smaller GPT models not trained on plurality of cloud computing platform documentations (e.g. Amazon cloud documentations, Azure documentations, Google cloud documentations, IBM cloud platform documentations, Alibaba cloud platform documentations, Salesforce cloud documentations, DigitalOcean Cloud documentations, Tencent Cloud documentations, etc.). However, this linearity may be punctuated by “break(s)” in the scaling law, where the slope of the line changes abruptly, and where larger models acquire “emergent abilities”. They arise from the complex interaction of the model's components and are not explicitly programmed or designed.

By way of example, the present GPT models the GPT model that is pre-trained on plurality of cloud computing platform documentations and generates human-like content summaries of the plurality of cloud computing platform documentations can Chain-of-thought (CoT) with respect to the plurality of cloud computing platform documentations content. The CoT capabilities of the GPT model with respect to the plurality of cloud computing platform documentations content allows for its LLMs to solve a problem as a series of intermediate steps before giving a final answer. Chain-of-thought prompting improves reasoning ability by inducing the model to answer a multi-step problem with steps of reasoning that mimic a train of thought. It allows large language models to overcome difficulties with some reasoning tasks that require logical thinking and multiple steps to solve, such as arithmetic or commonsense reasoning questions. In this way, the GPT model can exhibit commonsense reasoning. In one example, the commonsense reasoning can perform a human-like ability to make presumptions about the type and essence of ordinary situations humans encounter every day. These assumptions include judgments about the nature of massive documentations, physical objects, taxonomic properties of large documentations, and a human-users intentions with respect to queries and/or actions with respect to large pluralities of cloud-computing documentations.

It is noted that the GPT model automatically implements the CoT conduct with respect to the plurality of cloud computing platform documentations content based on the query from the human user to include a third judgment about a taxonomic structure of the plurality of cloud-computing documentations as the plurality of cloud-computing documentations are dynamically updated.

RAG can be used to obtain facts from an external knowledge base in order to ground LLMs in an accurate and most relevant information such that a user is provided at least one insight into LLMs' generative process. In this way, a RAG operation can be used to optimize the output of the LLM, so it references an authoritative knowledge base outside of its training data sources before generating a response. LLMs can be trained on vast volumes of data that include dynamically updated cloud-computing platform documentations that can provide billions of parameters to generate original output for tasks like answering questions, translating languages, and completing sentences. RAG extends the capabilities of LLMs to specific domains or an organization's internal knowledge base, without the need to retrain the model.

### Additional Example Computer Architecture and Systems

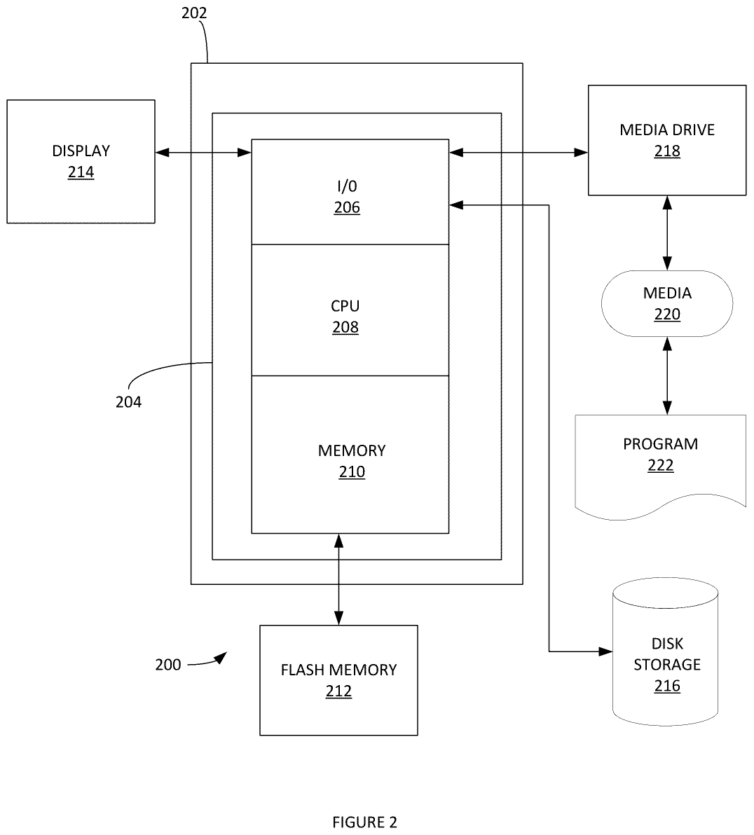

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A method of an managing policies in a multi-cloud governance platform comprising:
implementing AI-driven policy generation in the multi-cloud governance platform by:
providing at least one large language model (LLM) with sufficient size to have near or better than human reasoning abilities as an emergent property of the LLM;
providing a plurality of cloud-computing platform dynamically updated documentations;
with the LLM, interpreting an existing policy of a cloud-computing platform as provided in the plurality of cloud-computing platform dynamically updated documentations;
with the by the LLM, generating executable check, for a compliance with a policy of the cloud-computing platform; and
with the LLM, creating and maintaining a plurality of resources or activities associated with the policy for at least one cloud instance of the cloud-computing platform.

2. The method of claim 1, wherein the LLM comprises a GPT model.

3. The method of claim 2, wherein the GPT model comprises GPT-4 model.

4. The method of claim 2, wherein the GPT model comprises a plurality of artificial neural networks that are based on a transformer architecture, pre-trained on a plurality of large data sets of unlabeled text.

5. The method of claim 4 wherein the large data sets of unlabeled text comprises the plurality of dynamically-updated cloud computing platform documentations.

6. The method of claim 5, wherein the GPT model is pre-trained on the plurality of dynamically-updated cloud computing platform documentations on a periodic basis.

7. The method of claim 6, wherein the GPT model generates a novel human-like content summary of the plurality of cloud computing platform documentations based on a query from a user regarding at least one cloud computing platform documentation to a human-computer interface provided by the GPT model.

8. The method of claim 7, wherein the GPT model automatically implements a Chain-of-thought (CoT) conduct with respect to the plurality of cloud computing platform documentations content based on the query from the human user to include a first judgment about the nature of the content of the cloud computing platform documentation of the plurality of cloud-computing platforms.

9. The method of claim 8, wherein the GPT model automatically implements the CoT conduct with respect to the plurality of cloud computing platform documentations content based on the query from the human user to include a second judgment about the human-users intentions with respect to a user's intention for the query with respect to the plurality of cloud-computing documentations.

10. The method of claim 9, wherein the GPT model automatically implements the CoT conduct with respect to the plurality of cloud computing platform documentations content based on the query from the human user to include a third judgment about a taxonomic structure of the plurality of cloud-computing documentations as the plurality of cloud-computing documentations are dynamically updated.

11. The method of claim 10, wherein the taxonomic structure comprises a taxonomic substructure of a plurality of cloud instances each of the plurality of cloud-computing documentations.

12. The method of claim 11, wherein a GPT response is subsequently used to dynamically manage the plurality of cloud instances.

13. The method of claim 12, wherein the executable checks are generated for compliance with the policy of the cloud-computing platform using an SDKs for the target cloud-computing platform.

14. The method of claim 1, further comprising:
with the LLM, validating a plurality of compliance functions by seeding a reference instances with a set of test configurations that are then checked via the SDK functions to ensure they match the configuration state.

15. The method of claim 15, further comprising:
with the LLM, implementing an additional code to perform prompt engineering and a Retrieval Augmented Generation (RAG) operation to perform a semantic operation on a policy of a relevant cloud-computing platform.

16. The method of claim 16, further comprising:
eliciting a correct SDK code for each rule required by the policy.
